(19) United States
(12) Patent Application Publication
(10) Pub. No.: US 2007/0245758 A1
(43) Pub. Date: Oct. 25, 2007

(54) Component for a Motor Vehicle Structure

(76) Inventors: Georg Binder, Stuttgart (DE); Thomas Feith, Munchingen (DE); Andreas Grieb, Stuttgart (DE); Walter Wolf, Oppenweiler -Zell (DE)

Correspondence Address: FOLEY AND LARDNER LLP;SUITE 500, 3000 K STREET NW, WASHINGTON, DC, 20007, US

(21) Appl. No.: 10/591,532

(22) PCT Filed: Mar. 2, 2005
(86) PCT No.: PCT/EP05/02193

§ 371 Date: Jun. 26, 2007

(30) Foreign Application Priority Data
Mar. 2, 2004 (DE) 10 2004 010 616.9
Mar. 2, 2004 (DE) 10 2004 010 605.3
Mar. 19, 2004 (DE) 10 2004 013 984.9
Sep. 30, 2004 (DE) 10 2004 048 206.3

(51) Int. Cl. F25D 23/10; B60H 1/24

(52) U.S. Cl. 62/259.4; 454/142

(57) ABSTRACT

The invention relates to a component (1), particularly a composite component for a motor vehicle support, comprising a base body (2) which has interated air conditioning system modules (K1-K7), wherein the base body (2) extends in a cross direction (Y direction) and in at least one other direction (X direction, Z direction).

The invention relates to a component for a support of a vehicle, in particular for a transverse support.

A transverse support for arranging between the A pillars of a motor vehicle with an essentially tubular basic body in which at least one duct is provided is known from DE 100 64 522 A1. In order to provide an improved lightweight component which can be produced simply, with few work steps and therefore cost-effectively, the basic body is lined with plastic on the inside to form duct walls made of plastic.

Further embodiments of transverse supports with integrated air guides and associated air-guide and air-conducting elements are described in the following, as yet unpublished documents. For example, a transverse support with an integrated, demountable flap is described in DE 10 2004 048 206.3. An air-conducting element integrated into the transverse support is described in DE 10 2004 010 605.3. A transverse support with an integrated air-conducting and shut-off arrangement is described in DE 10 2004 010 616.9, and an air-conducting element integrated into outlet openings of the transverse support is described in DE 10 2004 013 984.9.

To sum up, the transverse supports known from the prior art have at least a partly integrated air guide and partly attached air-conditioning system parts. However, such transverse supports still leave desires unmet, in particular with regard to the number of parts and the associated production costs and also the large construction space required.

It is an object of the invention to provide an improved component for a support which is designed in a particularly compact, construction-space-saving way. This object is achieved by a component for a support with the features of claim 1. Advantageous developments form the subject matter of the dependent claims.

In this connection, the invention starts out from the consideration that, owing to the spatial arrangement and attachment of the air-conditioning system and its components, such as air guide, air distributor, air mixer and filter, too large a construction space is required for the mixing chamber along the transverse axis (also referred to as the Y axis) on the transverse support between the A pillars of the vehicle, which ought to be reduced. Available construction space therefore ought to be used particularly simply anyway. To this end, a component, in particular a composite or hybrid component, comprises a basic body which extends in the transverse direction and in at least one further direction, a number of air-conditioning system modules being integrated along the orientations of the basic body. Such a design of the component ensures a small construction space owing to the high degree of integration and the associated minimal spacing, or complete absence of spacing, of the air-conditioning system modules. Moreover, such a component has only a few interfaces, so that the number of seals, for example foam seals, is also reduced. Such an embodiment of the component also allows great design freedom as a large number of built-on items can be attached to the basic component. Furthermore, such a component can be produced, mounted and demounted simply and cost-effectively in a few steps.

The basic body preferably extends over the entire vehicle width along the transverse axis (also referred to as the Y axis). In addition, the basic body can extend at least partly along the longitudinal axis of the vehicle (also referred to as the X axis), for example longitudinally forward into the region of the windshield and/or backward into the vehicle interior, and/or at least partly along the vertical axis (also referred to as the Z axis), for example vertically upward and/or downward. In a preferred embodiment, the component extends over the entire vehicle width in the transverse direction and downward/upward at an angle in the longitudinal direction in the direction of the foot region/rear part region.

For an integration of the air-conditioning system modules in the component which saves as much construction space as possible, cavities of the component are used for integration. For this purpose, the basic body is formed from at least two parts, in particular two half-shells, which form cavities. The half-shells are metal half-body elements which serve as a basic hollow structure. The basic body forms a bearing basic hollow structure or a hollow body in the assembled state of the two parts. For production, mounting and demounting which are as simple as possible, the two parts are interconnected positively and non-positively and if appropriate separably from one another in the YZ plane or in the YX plane. For example, the parts are interconnected at the edges by joining, in particular welding, riveting or clipping.

For as high as possible a degree of integration of a number of air-conditioning system modules, the basic body extends in at least two directions, preferably in the transverse direction and in the longitudinal direction, and preferably has a T shape. A T shape makes symmetrical construction possible. The component can also be constructed asymmetrically depending on the way the vehicle is equipped. Asymmetrical construction means a largely one-sided integration and attachment of air-conditioning system modules in and to the basic body. For example, with the component arranged between the A pillars of the vehicle, there is a higher degree of integration on the passenger side than on the driver side. In addition, the basic body can have further branching structures. For example, the basic body has a cross shape. In this case, the basic body extends both in the transverse direction and also preferably centrally forward and backward in the longitudinal direction or upward and downward in the vertical direction.

In other words, the basic hollow structure follows the force paths for a cockpit, and the branching structures lie approximately at right angles or at an angle to the basic hollow structure. Depending on the design of the component, it has a central region from which lateral arms and/or tunnel offtakes extend. To form a hollow structure, the lateral arms and/or tunnel offtakes have a cross section which consists of two half-bodies, in particular two half-shell-shaped elements, for example two U shells, two Z shells or other shell shapes. For sufficiently good strength, the basic body is made from a material with a high elastic modulus, in particular from metal, for example from aluminum, magnesium, steel, titanium or also from a composite material, for example a plastic/plastic hybrid. The basic body is preferably made as a finished part, in particular a separate prefabricated component, which is lined at least partly with plastic. This makes flexible construction and easy mounting possible. Furthermore, various parts can be designed in such a way that they can be used in different construction series.

An air guide duct which is formed by at least one of the cavities of the basic body is integrated in the body as a possible air-conditioning system module. For this, the metal basic body is lined at least partly with plastic, the cavities of the basic body forming a flow duct for a medium flowing through, in particular an air guide duct. In one possible embodiment, the air guide duct extends from a central, in particular centric, region of the basic body in the Y direction via lateral arms and/or in the Z or X-Z direction via tunnel offtakes toward at least one side, toward the floor and/or toward the windshield. That is the air guide duct extends in the cavities of the basic structure or of the basic body at least transversely to the direction of travel (=Y axis) and in addition in the Z direction or at an angle in the X-Z direction. For best possible distribution of the conditioned air in the vehicle interior, a number of flow openings for inlet and/or outlet of air are provided at the beginning and end of the basic body, in particular at the beginning and end of the lateral arms and/or tunnel offtakes.

In a simple embodiment of the component, the air guide duct is made in the form of a plastic lining of the basic body. The component is designed as a hybrid or composite component. A hybrid part means in particular a metal/plastic component. In this connection, the metal basic body is produced as a finished part. Lining with plastic is effected using a hybrid technique, for example IMA (in-mold assembly) or PMA (post-mold assembly) or in another way, for example gluing in or clipping a finished plastic part. In the PMA method, the plastic part is pressed into the metal basic body, a metal sheet, after the injection-molding process by means of a mechanical joining method, for example with the aid of a pressing device (“collar”). These collars ensure firm adhesion with the plastic in the finished component by virtue of their special shape. The basic body is further rigidified and strengthened by the integration of the plastic components into the basic hollow structure and consequently into the basic body.

The plastic components consequently take on a bearing and in particular rigidifying function and further air-conditioning system functions such as air distribution and air guidance.

In another embodiment for a high degree of integration, an air mixer is integrated as a further air-conditioning system module. In this connection, the air mixer is formed in one of the cavities of the basic body, in particular in the central region of the basic body and/or at flow outlet openings of the basic body. In addition, an air distributor which is likewise formed by one of the cavities of the basic body is integrated as a further air-conditioning system module. The evaporator, the heating arrangement, the air mixer and/or the air distributor form a thermomodule for temperature control, that is for air temperature control and conditioning, for example heat, cold and filter. A structural module formed by the air guide duct adjoins the preferably centrally arranged thermomodule. The component consequently consists of a thermomodule for air temperature control and conditioning and a structural module for air distribution and air guidance.

At least one air-conducting element, for example an air-conducting, air-distributing and/or air quantity control arrangement, for controlling the flow rate and for air distribution is integrated in the basic body for uniform and individually adjustable air-conditioning of the vehicle interior. Depending on function, the air-conducting element is designed as a nozzle, a flap, in particular a butterfly flap, a swing flap, a roller flap and/or a louver or roll band flap or cassette. Depending on construction of the component, the air-conducing element can be arranged in the air guide duct and/or at the beginning or at the end of the air guide duct. The air-conducting element is preferably made of plastic, in particular as an injection-molded part, and elastic sealing edges can be provided directly on the air-conducting element.

For conditioning the air, an air temperature control and air-conditioning unit, for example heating element and evaporator, is integrated in or attached to one of the cavities of the basic body as an air-conditioning system module. The air temperature control and air-conditioning unit is preferably attached centrally to the basic body or integrated at least partly into it, in particular in the thermomodule of the basic body. By means of the thermomodule integrated in the central region of the basic body, the conditioned air is then supplied via the structural module—the air guide duct—into the vehicle interior, for example to the foot and floor space for ventilation, to the region of the windshield for defrosting, to the rear part region for ventilation.

In addition, a filter can be integrated in or attached to one of the cavities of the basic body as an air-conditioning system module. For example, the filter is at least partly integrated in or attached to the thermomodule of the basic body for filtering odor and particles. A humidity control and/or fragrance management can also form part of the thermomodule.

For a more extensive construction-space-saving function of the component, further functional modules, in particular a head-up display, an audio and/or communication unit, a navigation unit and/or an operating and information unit, and also media lines and cabling can be integrated in or attached to one of the cavities of the basic body.

For production which is as simple and cost-saving as possible, the basic body is embodied as a finished part (=separate prefabricated component) which is at least partly lined with plastic for forming the thermomodule with the integrated air-conditioning system modules. Alternatively, the thermomodule with the air-conditioning system modules can also be embodied as a finished part. This is integrated in or attached to the basic body. In this connection, the thermomodule is made at least partly of plastic, the thermomodule consisting of plastic mounting parts and/or of injected or injected-on plastic parts and preferably forming a rigidifying structure for the basic body.

The component is preferably used as a transverse support for a vehicle. The component consequently takes on both bearing functions and functions relating to the air-conditioning. On account of the high degree of integration of air-conditioning system modules in the basic body of the component, the component is also designated as a thermo/structural module.

Illustrative embodiments of the invention are explained in greater detail with reference to a drawing, in which:

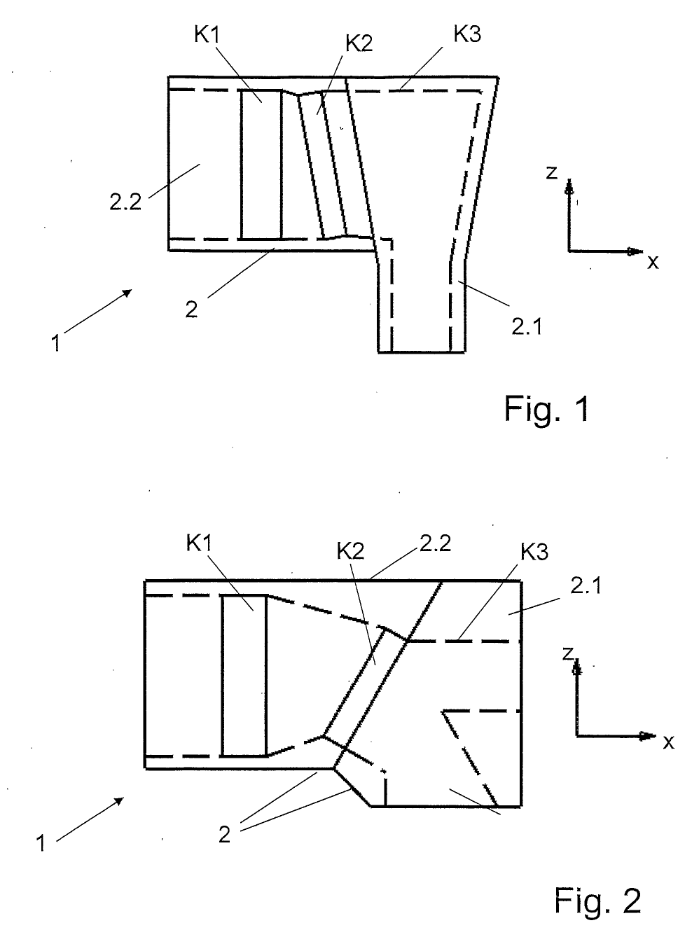

FIG. 1 shows a section through a component extending in two orientations for a transverse support with integrated air-conditioning system modules;

FIGS. 2 to 4 show various embodiments of a component extending in at least two orientations with integrated air-conditioning system modules;

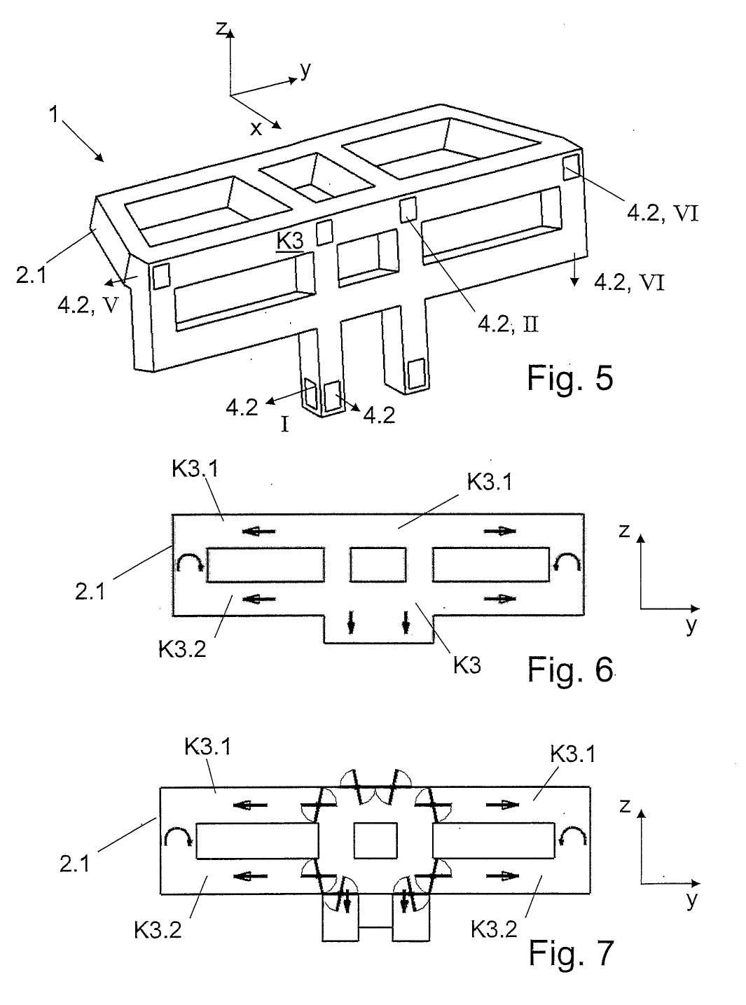

FIG. 5 shows a perspective view of an embodiment of a component;

FIGS. 6, 7 show a vertical section through a component with integrated air guide ducts;

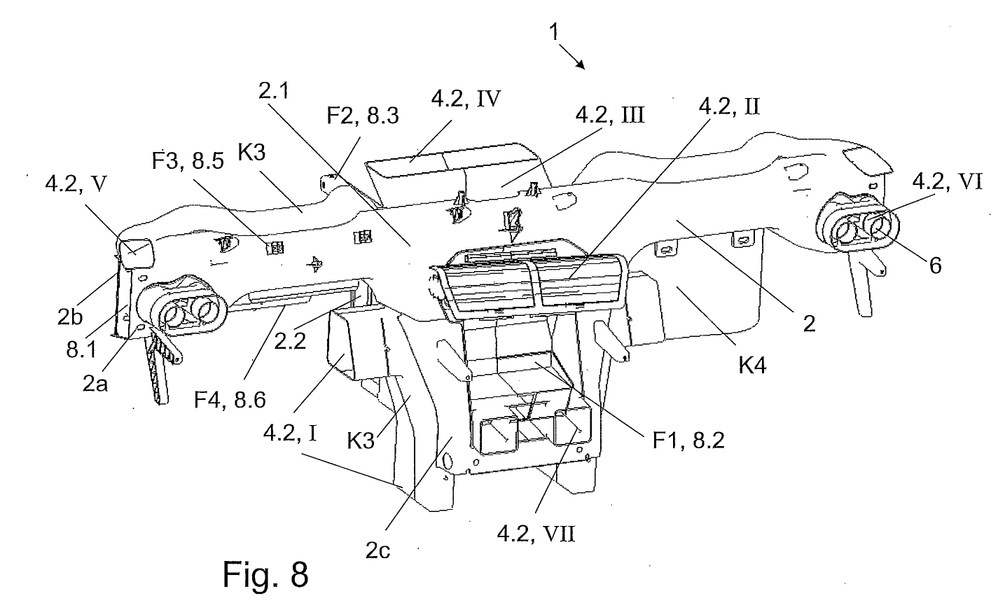

FIG. 8 shows a perspective detailed view of a component designed as a transverse support with a number of attached functional modules;

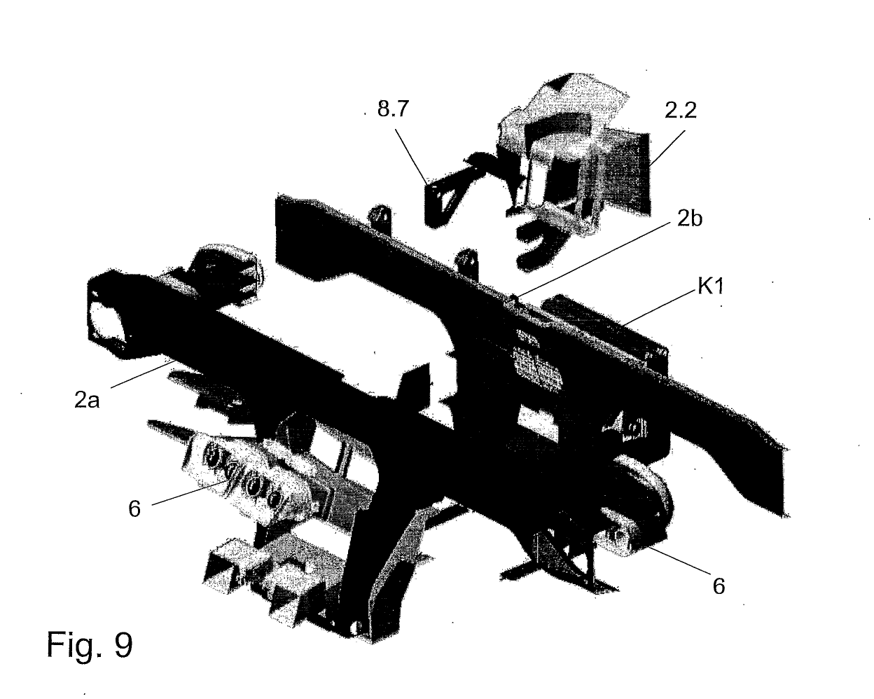

FIG. 9 shows another perspective detailed view of the component illustrated in FIG. 8 in an exploded illustration;

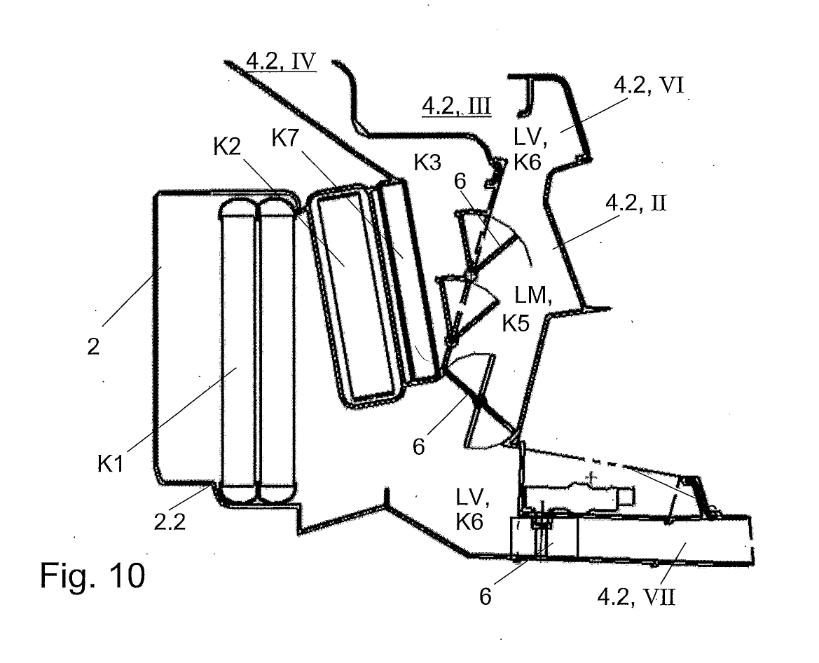

FIG. 10 shows a Y0 section through the component without functional modules attached;

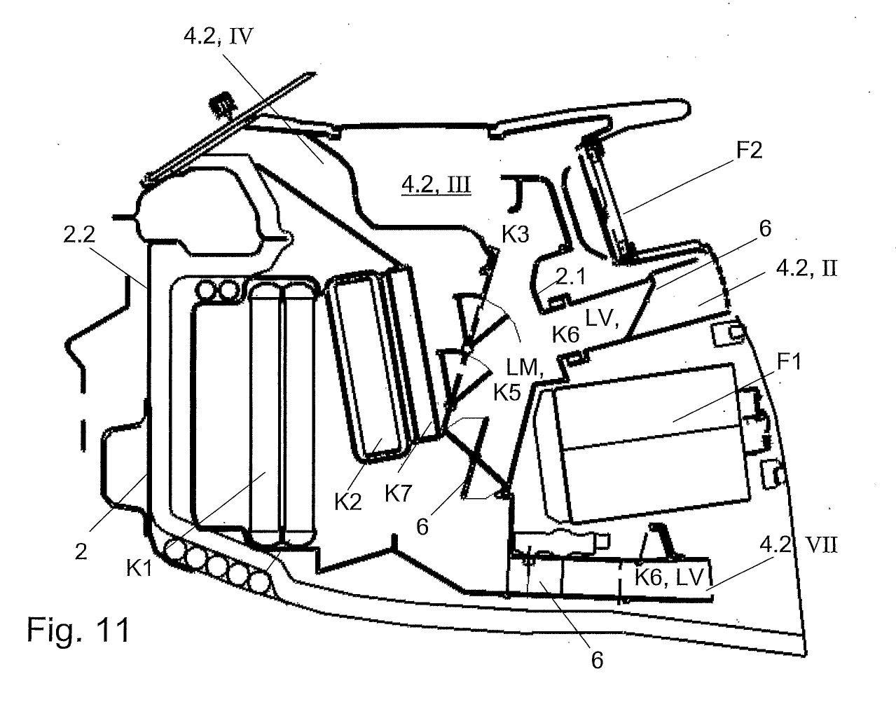

FIG. 11 shows a section corresponding to FIG. 10 through a variant of the component with functional modules attached;

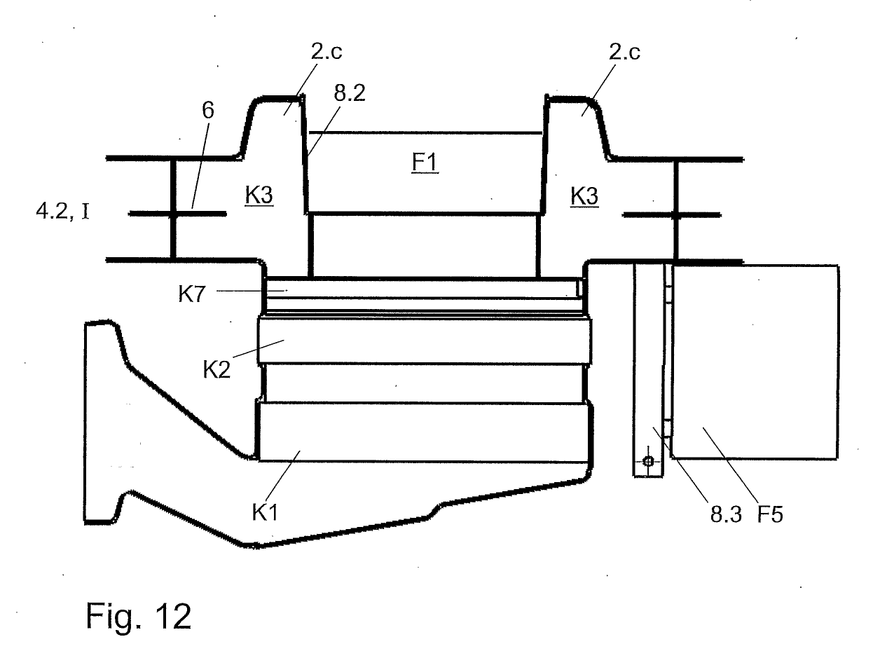

FIG. 12 a Z section in the central region of the component according to FIG. 10;

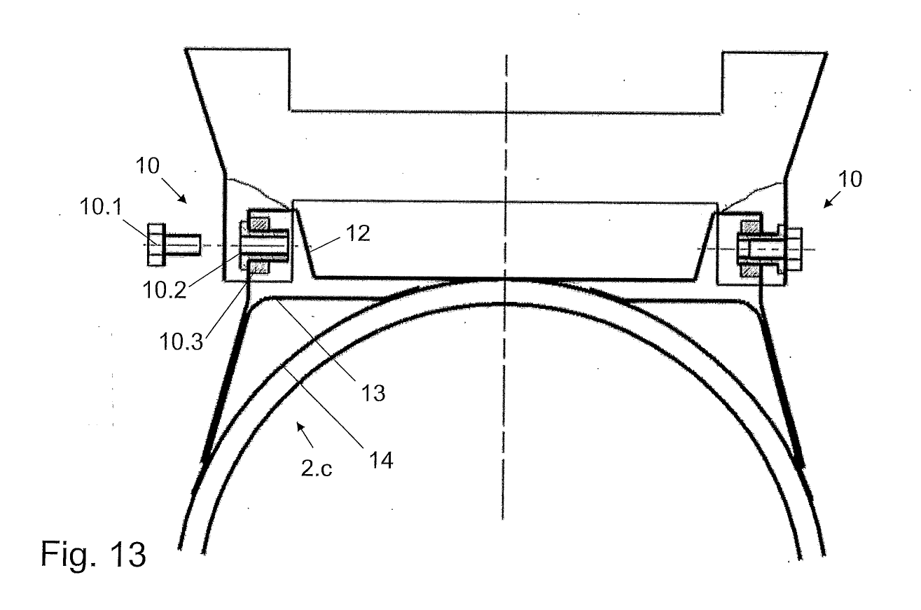

FIG. 13 shows a section in the region of a tunnel attachment of the component with a tolerance element for the tunnel support;

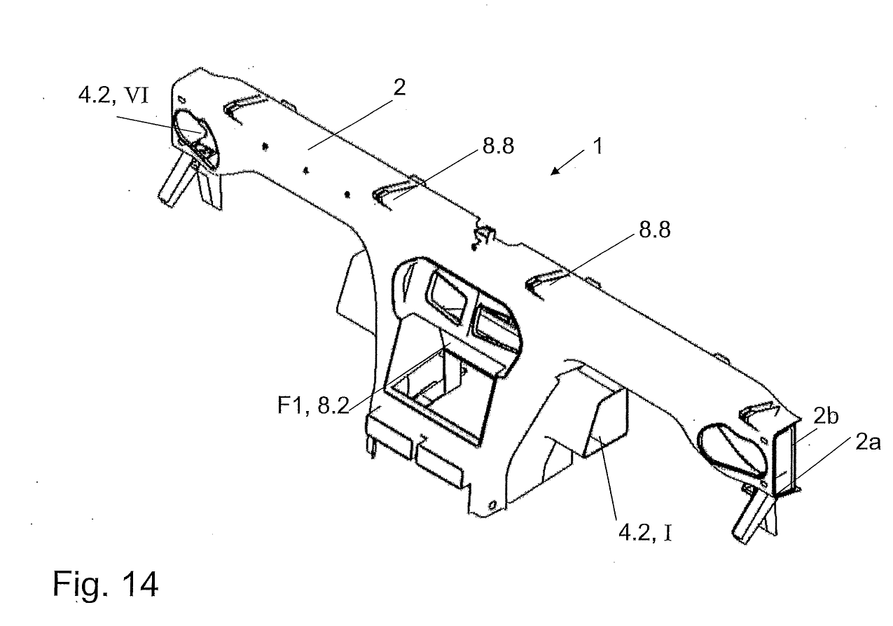

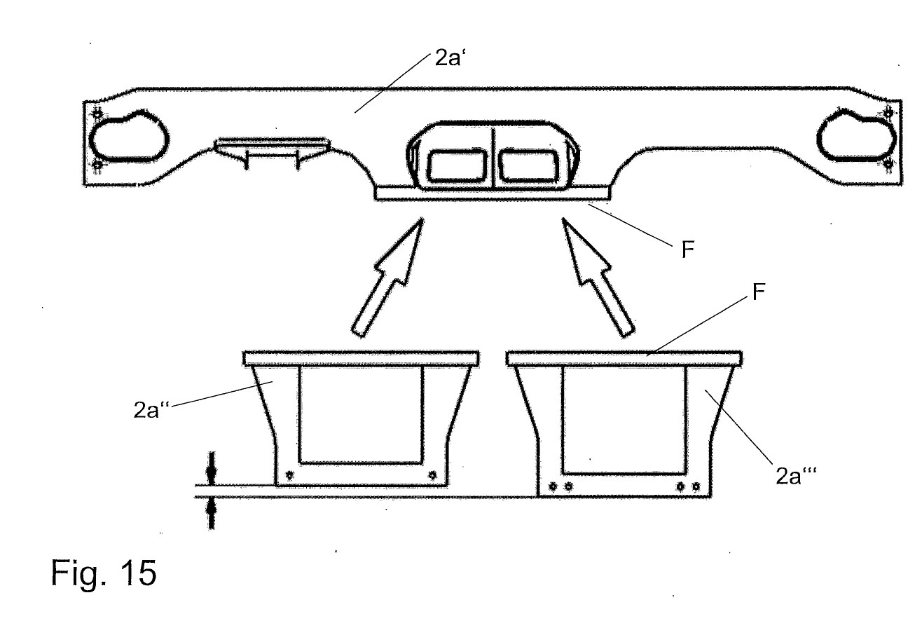

FIG. 14 shows a perspective view of a component with a number of integrated formations made of plastic for air-conditioning system modules and mounting holders, and

FIG. 15 shows a perspective view of a multipart half-shell for a basic body of the component.

Corresponding parts are provided with the same reference signs in all the figures.

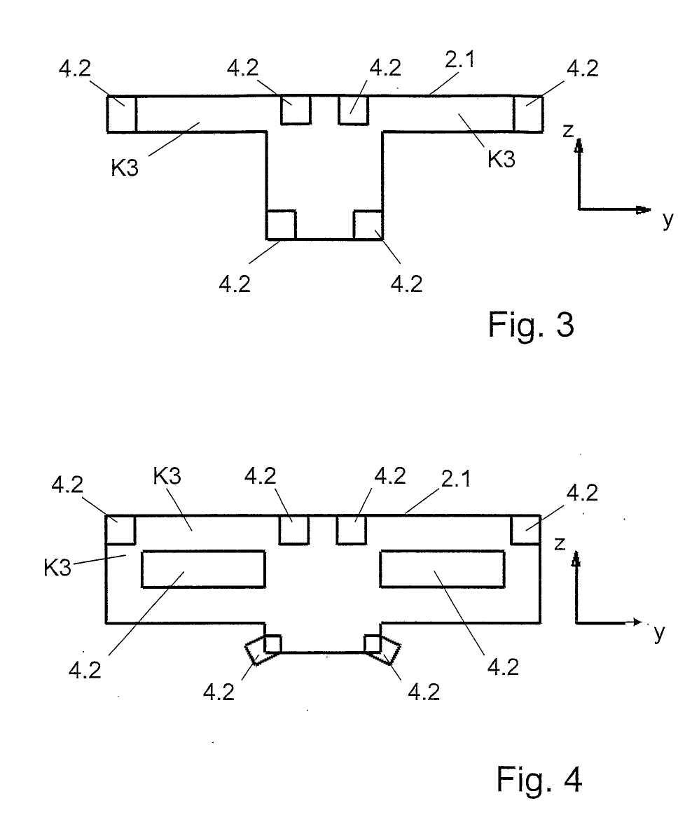

FIG. 1 shows a component 1 for a support of a vehicle. The component 1 comprises a basic body 2 with a number of integrated air-conditioning system modules K1 to Kn, for example an evaporator K1, a heating arrangement K2 and an air guide duct K3. In this connection, the basic body 2 extends in at least two orientations. Two illustrative embodiments for the basic body 2 extending in the X direction and in the Z direction are shown in FIG. 1 and in FIG. 2. In this connection, the X direction means the orientation of the basic body 2 along the vehicle longitudinal axis. The Z direction means the orientation of the basic body 2 upward or downward along the vertical axis. The basic body 2 preferably extends in the transverse direction of the vehicle, that is in the Y direction, as illustrated in FIGS. 3 and 4, and is arranged as a transverse support between the A pillars of the vehicle. In this connection, the basic body 2 does not only serve as a bearing structure. By virtue of integration of the air-conditioning system modules K1 to K3 into and/or onto the basic body 2, the component 1 is also designated as a thermo/structural module.

As illustrated in FIGS. 1 and 2, the basic body 2 is formed from a number of modules 2.1 to 2.2. The module 2.1 is designed as a basic hollow structure, the cavities being used for air guidance and air distribution by means of the air guide duct K3. In this connection, the module 2.1 (referred to as structural module 2.1 below) follows the force paths for a cockpit and extends in the Y direction and moreover in the X direction and in the Y direction (see FIGS. 1 to 4).

Further modules 2.2 can be attached to the structural module 2.1. The module 2.2 thus comprises parts or components of an air-conditioning system for air temperature control and air conditioning, such as for example the evaporator K1 and a heating element K2. The module 2.2 is therefore also designated as a thermomodule below. In this connection, fresh air or circulating air is supplied to the evaporator K1 and the heating arrangement K2 for conditioning via one or more air inlet openings. Via the air guide duct K3, the conditioned air is guided into the vehicle interior, for example the foot and floor region I, into the central front region II, for indirect ventilation III, into the windshield region IV, onto the side window V, into the lateral interior region VI and into the rear part region VII, via air outlet openings 4.2.

FIG. 5 shows a perspective illustration of the component 1 with the basic body 2 extending in the Y, X and Z directions with a number of air outlet openings 4.2 for supplying conditioned air into the vehicle interior.

FIGS. 6 and 7 show further illustrative embodiments of the structural module 2.1 with alternative embodiments of the air guide duct K3 as a single-chamber or multi-chamber duct. In an embodiment as a multi-chamber duct, cold or fresh air is guided in a first chamber duct K3.1 and hot air is guided in a second chamber duct K3.2. At the end of the air guide duct K3, the fresh air and hot air guided in the separate chamber ducts K3.1 and K3.2 are mixed at the air outlet openings 4.2 and supplied to the vehicle interior as conditioned air. In an embodiment as a single-chamber duct K3.1 or K3.2, air which has already been conditioned, that is a mixture of cold air and hot air, is guided in these air guide ducts. In FIG. 7, integrated air-conducting elements 6 such as for example shut-off or proportioning elements, in particular air flaps, which control or regulate the air inlet and/or outlet into/from different regions of the basic body 2 and/or of the vehicle interior are illustrated diagrammatically.

FIG. 8 shows a perspective view of a component 1 with a structural module 2.1 extending in the Y direction and in the Z direction and with air-conditioning system modules K1 to K3 integrated into a thermomodule 2.2. Parts of the air guide duct K3 are integrated both into the structural module 2.1 and into the thermomodule 2.2. For this purpose, the structural module 2.1 is formed from two parts 2a and 2b, in particular from two half-shells, which form cavities. The basic body 2 consequently forms a bearing basic hollow structure. By virtue of the basic body 2 being used as a transverse support and its orientation in the Y direction and in the Z direction, the basic body 2 has a T shape, which is suitable for symmetrical construction. In this connection, the integration of the air-conditioning system modules K1 to K3 into the basic body 2 is carried out symmetrically or asymmetrically depending on function. Symmetrical construction, in particular of the air guide duct, is particularly cost-effective in production. The T-shaped basic body 2 has an integrated tunnel support 2c in the Z direction. In addition to the air-conditioning system modules K1 to K3, a filter for filtering the air, integrated into a housing which forms part of the thermomodule 2.2, is provided as a further air-conditioning system module K4.

The two half-shells 2a and 2b forming the structural module 2.1 of the basic body 2 are in each case a metal structure which is produced for example by means of extrusion, roll-profiling or rolling and subsequent machining, inter alia the long-side ends being formed. Other kinds of production, such as in particular deep drawing, are likewise possible. The integrated air-conditioning system modules K1, K2 and/or K4 are inserted into or attached to finished plastic mounting parts of the thermomodule 2.2, the plastic mounting parts of the thermomodule being attached, for example injection-molded, glued or clipped, to the basic body 2 as injected or injected-on plastic parts. The injected or injected-on or joined plastic parts form in addition a rigidifying structure for the basic body 2. The basic body 2 and the integrated air-conditioning system modules K1 to K4 can be embodied as a separate prefabricated component. This makes simple and cost-effective production and mounting possible.

The component 1 can be fastened in the vehicle, for example to the A pillar, via an attachment 8.1, for example a clip or laterally arranged brackets. To limit deformation of the end regions by excessive force action, for example from mounting screws, supporting bodies are arranged in the interior of the component 1, in particular of the basic body 2.

The two metal half-shells 2a, 2b are joined together in a known way. The inner space between the two half-shells 2a and 2b is hollow, so that direct passage of air is possible. Part of the ventilation system is thus integrated directly into the basic body 2. For this, the half-shells 2a, 2b have a number of air outlet openings 4.2 for air outlet into the vehicle interior, for example into the foot or floor region I, for front central ventilation II, for indirect ventilation III, into the windshield region IV (=defrost), into the side window region V, into the lateral interior region VI and/or into the rear part region VII. Moreover, an air mixer LM and an air distributor LV are formed as further air-conditioning system modules K5 to K6 in the centric or central region of the basic body 2 with the largest cavity. The air distributor LV consists essentially of distributing ducts and/or air-conducting elements 6. In contrast to the air distributor LV, the air mixer LM has air-conducting elements 6 which also serve for mixing differently conditioned air, for example hot air and cold air. Depending on type and construction of the component 1, the air mixer LM and the air distributor LV can form an integral part of the thermomodule 2.2 and/or of the structural module 2.1. In particular, the air mixer LM is directly adjacent to the evaporator K1 and the heating arrangement K2. Alternatively, the air mixer LM can also be arranged at one of the flow exits 4.2 if the air guide duct K3 is designed as a multi-chamber duct.

Air-conducting elements 6 are arranged in the air outlet openings 4.2 for adjusting the air flowing into the vehicle interior. Nozzles, for example central and lateral nozzles, and flaps, for example butterfly flaps, swing flaps and/or roller flaps, for example, serve as air-conducting elements 6, for example. Moreover, air mixing by means of the air mixer LM (air-conditioning system module K5) is made possible by the central cavity of the air guide duct K3, which is directly adjacent to the thermomodule 2.2, the hot air supplied by the heating module K2 being mixed together with cold air or fresh air supplied and being distributed along the orientations of the basic body 2 to the branching structures of the air guide duct 3 via the air distributor LV (air-conditioning system module K6).

In addition, further functional modules, for example an audio and communication unit Fl, a navigation unit and/or an operating and information unit F2 or a head-up display F5, can be attached to or integrated into the basic body 2. For this, the basic body 2 comprises corresponding attachments 8.2 and 8.3. In this connection, the attachment 8.2 is designed as an integrated insertion compartment and the attachment 8.3 as a holder. Moreover, further integrated plastic formations can be provided as attachments 8.5, 8.6 for mounting an instrument panel F3 or a steering assembly F4.

FIG. 9 shows the component 1 according to FIG. 8 in an exploded illustration. In addition to the components illustrated in FIG. 8, an attachment 8.7 for the thermomodule 2.2 for receiving the air-conditioning system modules K1 and K2 is illustrated in FIG. 9. For clearer illustration, FIG. 9 shows only part of the thermomodule 2.2, in this case only one half-shell side of a centrally separated thermomodule 2.2. The air-conducting elements 6 in the central ventilation region are illustrated without louvered flaps mounted in front.

FIG. 10 shows a Y0 section through the component 1 without functional modules F1 and F2 attached. The basic body 2 is illustrated with the integrated air-conditioning system modules K1, K2 and K3 and also an air-mixing module K5 and air-distributing modules K6. In this connection, a number of air-conducting elements 6, for example in the form of flaps, such as butterfly flaps or wing flaps, are provided for controlling and guiding the air in the air guide duct K3 into the relevant regions of the vehicle interior. An additional heating unit, for example an electric heating unit such as a PTC additional heater, is provided in the thermomodule 2.2 of the component 1 as an additional air-conditioning system module K7.

FIG. 11 shows a section corresponding to FIG. 10 through a varIant of the component 1 with the functional modules F1 (=audio and communication unit) and F2 (=operating and information unit) attached to the structural module 2.1. A further air-distributing module K6 in the form of a central ventilation nozzle with an air-conducting element 6 is illustrated in the central region.

FIG. 12 shows a Z section in the central region of the component 1 according to FIG. 10 with the functional modules F1 (=audio and communication unit) and F5 (=head-up display) attached via their attachments 8.2 and 8.3. The integrated tunnel support 2c of the structural module 2.1 comprises an integrated hot-air duct as an air-conditioning system module K3.

FIG. 13 shows in detail a section in the region of the tunnel support 2c with a tolerance compensation element 10. In order to reduce strains, tolerance compensation is brought about in the Y direction by means of the tolerance compensation element 10. The tolerance compensation element 10 comprises a screw 10.1 and a weld nut 10.2 and also a compensation element 10.3 with a double thread, in particular with a right-hand thread and a left-hand thread. The tunnel support 2c is fastened to a tunnel 14 by means of the tolerance element 10 via a holder 12 and a reinforcement 13, for example in the form of a metal sheet. In this case, the tolerance element 10 is illustrated before mounting in the left part and in the mounted state in the right part of FIG. 13. optionally, mounting can also take place on only one side with a tolerance element 10.

FIG. 14 shows a perspective view of the component 1 with a number of integrated formations made of plastic and attachments 8.8 as mounting holders. Moreover, the air guide duct K3 formed from the two joined half-shells 2a and 2b is illustrated.

FIG. 15 shows a perspective view of a multi-part half-shell 2a of the structural module 2.1, consisting of an upper part 2a′ and a lower part 2a″ for a basic body 2 of the component 1. The parts of the half-shell 2a are joined, for example welded, to one another in the joining region F. FIG. 15 shows two parts 2a″ of different length in the Z direction which can be joined together to form a basic body 2. It is thus possible, by exchanging a part 2a″ of the half-shell 2a, or of the basic body 2, to carry out simple adaptation to different vehicle dimensions in the Z direction without changing major parts or regions of the basic body 2.

1. A component, in particular composite component for a support of a vehicle, comprising a basic body with integrated air-conditioning system modules (K1 to K6), the basic body extending in the transverse direction (Y direction) and in at least one further direction (X direction, Z direction).

2. The component as claimed in claim 1, the basic body extending at least partly in the longitudinal direction (X direction) of the vehicle.

3. The component as claimed in claim 1, the basic body extending at least partly in the vertical direction (Z direction) of the vehicle.

4. The component as claimed in claim 1, the basic body (2) extending in the direction of the foot region (I) and/or the rear part region (VII).

5. The component as claimed in claim 1, the basic body being formed from at least two parts, in particular two half-shells which form cavities.

6. The component as claimed in claim 5, the two parts being interconnected positively and non-positively in the YZ plane or in the YX plane.

7. The component as claimed in claim 1, the basic body forming a bearing basic hollow structure which has a T shape.

8. The component as claimed in claim 7, the basic body having further branching structures.

9. The component as claimed in claim 1, an air guide duct which is formed by at least one of the cavities of the basic body being integrated as an air-conditioning system module.

10. The component as claimed in claim 9, the air guide duct extending from a central region of the basic body toward at least one side, toward the floor and/or toward the windshield and being provided with a number of flow openings for inlet and/or outlet of air.

11. The component as claimed in claim 1, an air mixer which is formed in one of the cavities of the basic body, in particular in the central region of the basic body and/or at flow exit openings of the basic body, being integrated as a further air-conditioning system module.

12. The component as claimed in claim 1, an air distributor which is formed by one of the cavities of the basic body, in particular in the central region of the basic body, being integrated as a further air-conditioning system module.

13. The component as claimed in the air-conditioning system modules (K1 to K6) serving for conditioning the air forming a thermomodule of the basic body.

14. The component as claimed in claim 1, at least one air-conducting element for controlling the flow rate and for air distribution being integrated in the basic body.

15. The component as claimed in claim 14, the air-conducting element being designed as a nozzle, a flap, in particular a butterfly flap, a swing flap, a louver or roll band flap or cassette and/or a roller flap.

16. The component as claimed in claim 14, the air-conducting element being provided in the air guide duct and/or at the beginning or at the end of the air guide duct.

17. The component as claimed in claim 1, an air temperature control and air-conditioning unit, in particular an evaporator and a heating unit, being integrated in or attached to one of the cavities of the basic body as an air-conditioning system module.

18. The component as claimed in claim 1, a filter being integrated in or attached to one of the cavities of the basic body R) as an air-conditioning system module.

19. The component as claimed in claim 1, further functional modules, in particular a head-up display, an information display, a combined instrument, an audio and/or communication unit, a navigation unit and/or an operating and information unit, being integrated in or attached to one of the cavities of the basic body.

20. The component as claimed in claim 1, the basic body being embodied as a finished part which is at least partly lined with plastic.

21. The component as claimed in claim 1, a thermomodule having one or more air-conditioning system modules in each case being embodied as a finished part which is made at least partly of plastic.

22. The component as claimed in claim 1, the thermomodule consisting of plastic mounting parts and/or the plastic mounting parts forming as injected or injected-on plastic parts a rigidifying structure for the basic body.

23. Use of a component as claimed in claim 1 as a transverse support for a vehicle.
